(19) United States
(12) Patent Application Publication
(10) Pub. No.: US 2023/0052325 A1
(43) Pub. Date: Feb. 16, 2023

(54) SCREEN SHARE FEATURE FOR ONLINE MEETINGS

(71) Applicant: Citrix Systems, Inc., Fort Lauderdale, FL (US)

(72) Inventors: Anirudh Katoch, New Delhi (IN); Divyansh Deora, Rajasthan (IN); Ramadas S. Mahale, Bangalore (IN)

(21) Appl. No.: 17/401,768

(22) Filed: Aug. 13, 2021

(51) Int. Cl. G06Q 10/10; G06F 21/60

(52) U.S. Cl. CPC G06Q 10/109; G06F 21/602; G06Q 2220/10

(57) ABSTRACT

In one aspect, an example methodology implementing the disclosed techniques includes, by a computing device, storing one or more encrypted files that are to be presented during an online meeting and receiving an acceptance to an invitation of the online meeting by at least one invitee of the online meeting. The method also includes, by the computing device, responsive to the acceptance of the online meeting invitation by the at least one invitee, sending the one or more encrypted files that are to be presented during the online meeting, wherein the invitee is prevented from accessing contents of the one or more encrypted files prior to a start of the online meeting.

### BACKGROUND

Due at least in part to the growth of high-speed networks such as the Internet, online conferencing (also known as web conferencing or online meetings) has become a prevalent mechanism for conducting meetings. Online meetings allow people in geographically dispersed locations to attend or participate in an online meeting without having to travel to a remote location. Online meeting applications provide features that allow attendees of an online meeting to collaborate and share information. For instance, online meeting applications commonly provide screen sharing features that allow a presenter in the meeting to share content from his/her computer screen with other attendees in the meeting.

### SUMMARY

This Summary is provided to introduce a selection of concepts in simplified form that are further described below in the Detailed Description. This Summary is not intended to identify key or essential features or combinations of the claimed subject matter, nor is it intended to be used to limit the scope of the claimed subject matter.

As noted above, an online meeting can often involve sharing content amongst multiple attendees of the online meeting. Screen sharing, as happens when a meeting presenter shares the contents displayed on his/her screen, usually involves the presenter's computing device continuously sending a video (i.e., a video stream or feed) of the contents of the device's screen to an online meeting server over a computer network. The online meeting server receives the video and distributes the video to the computing devices of the other meeting attendees for rendering on the screens of these computing devices. This allows the other meeting attendees to view (watch) the content that is being displayed on the screen of the meeting presenter's computing device. However, various problems could arise with screen sharing when the online meeting is conducted over low or insufficient bandwidth network connections. The low or insufficient bandwidth connections may be between the meeting presenter's computing device and the online meeting server and/or the online meeting server and a computing device(s) of the other meeting attendee(s). In any case, as the frames of the presenter's screen are continuously being sent over these low or insufficient bandwidth network connections, the other meeting attendees are likely to see a distorted version of the contents of the presenter's screen. In addition, the computing devices of the other meeting attendees may receive the frames at different times depending on the bandwidths of the connections to their computing devices. Embodiments of the present disclosure provide solutions to these and other technical problems described herein.

In accordance with one example embodiment provided to illustrate the broader concepts, systems, and techniques described herein, a method may include, by a computing device, storing one or more encrypted files that are to be presented during an online meeting and receiving an acceptance to an invitation of the online meeting by at least one invitee of the online meeting. The method may also include, by the computing device, responsive to the acceptance of the online meeting invitation by the at least one invitee, sending the one or more encrypted files that are to be presented during the online meeting, wherein the invitee is prevented from accessing contents of the one or more encrypted files prior to a start of the online meeting.

According to another illustrative embodiment provided to illustrate the broader concepts described herein, a system includes a memory and one or more processors in communication with the memory. The processor may be configured to receive one or more encrypted files that are to be presented during an online meeting and receive an acceptance to an invitation of the online meeting by at least one invitee of the online meeting. The processor may be further configured to, responsive to the acceptance of the online meeting invitation by the at least one invitee, send the one or more encrypted files that are to be presented during the online meeting, wherein the invitee is prevented from accessing contents of the one or more encrypted files prior to a start of the online meeting.

According to another illustrative embodiment provided to illustrate the broader concepts described herein, a method may include detecting, by an online meeting client application executing on a computing device, an operation on a file while content is being shared during an online meeting. The method may also include, responsive to the detection, sending, by the online meeting client application to an online meeting server application that is hosting the online meeting, a first command to perform the operation on the file, wherein the online meeting server application is to forward the first command to perform the operation on the file to at least one attendee in the online meeting.

According to another illustrative embodiment provided to illustrate the broader concepts described herein, a computing device includes a memory and one or more processors in communication with the memory. The processor may be configured to detect an operation on a file while content is being shared during an online meeting and, responsive to the detection, send a first command to perform the operation on the file to an online meeting server that is hosting the online meeting, wherein the online meeting server application is to forward the first command to perform the operation on the file to at least one attendee in the online meeting.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 is a diagram of an illustrative network computing environment in which embodiments of the present disclosure may be implemented.

FIG. 2 is a block diagram illustrating selective components of an example computing device in which various aspects of the disclosure may be implemented, in accordance with an embodiment of the present disclosure.

FIG. 3 is a schematic block diagram of a cloud computing environment in which various aspects of the disclosure may be implemented.

FIG. 4 is a block diagram of an example online meeting system that can be used to provide screen sharing, in accordance with an embodiment of the present disclosure.

FIG. 5 is a block diagram illustrating an example implementation of an online meeting client application, in accordance with an embodiment of the present disclosure.

FIG. 6 is a sequence diagram showing an example flow of interactions between various components to perform screen sharing during an online meeting, in accordance with an embodiment of the present disclosure.

FIG. 7 is a sequence diagram showing an example flow of interactions between various components to perform screen sharing during an online meeting, in accordance with an embodiment of the present disclosure.

### DETAILED DESCRIPTION

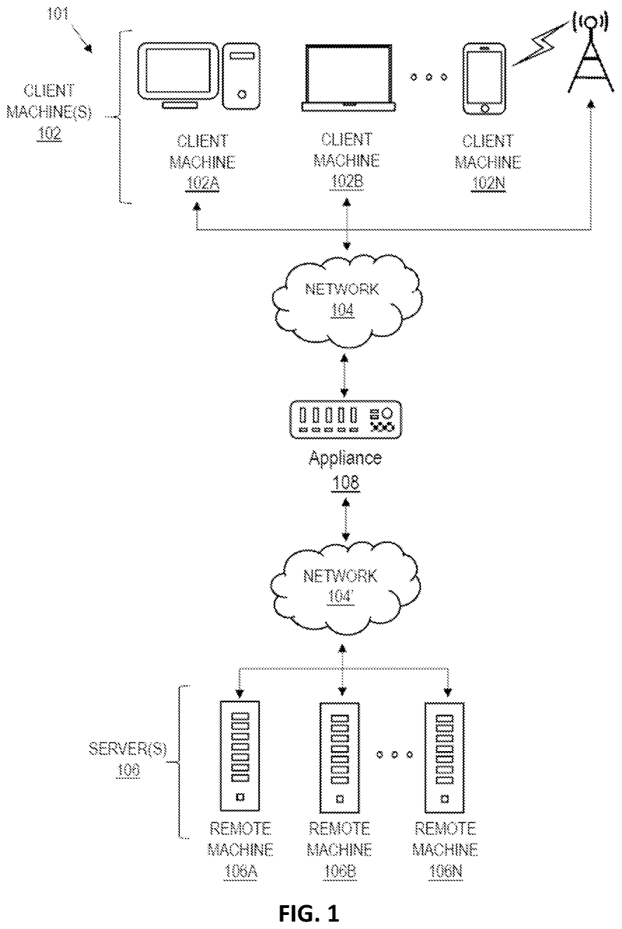

Referring now to FIG. 1, shown is an illustrative network environment 101 of computing devices in which various aspects of the disclosure may be implemented, in accordance with an embodiment of the present disclosure. As shown, environment 101 includes one or more client machines 102A-102N, one or more remote machines 106A-106N, one or more networks 104, 104′, and one or more appliances 108 installed within environment 101. Client machines 102A-102N communicate with remote machines 106A-106N via networks 104, 104′.

In some embodiments, client machines 102A-102N communicate with remote machines 106A-106N via an intermediary appliance 108. The illustrated appliance 108 is positioned between networks 104, 104′ and may also be referred to as a network interface or gateway. In some embodiments, appliance 108 may operate as an application delivery controller (ADC) to provide clients with access to business applications and other data deployed in a datacenter, a cloud computing environment, or delivered as Software as a Service (SaaS) across a range of client devices, and/or provide other functionality such as load balancing, etc. In some embodiments, multiple appliances 108 may be used, and appliance(s) 108 may be deployed as part of network 104 and/or 104′.

Client machines 102A-102N may be generally referred to as client machines 102, local machines 102, clients 102, client nodes 102, client computers 102, client devices 102, computing devices 102, endpoints 102, or endpoint nodes 102. Remote machines 106A-106N may be generally referred to as servers 106 or a server farm 106. In some embodiments, a client device 102 may have the capacity to function as both a client node seeking access to resources provided by server 106 and as a server 106 providing access to hosted resources for other client devices 102A-102N. Networks 104, 104′ may be generally referred to as a network 104. Networks 104 may be configured in any combination of wired and wireless networks.

Server 106 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

Server 106 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, server 106 may execute a remote presentation services program or other program that uses a thin-client or a remote-display protocol to capture display output generated by an application executing on server 106 and transmit the application display output to client device 102.

In yet other embodiments, server 106 may execute a virtual machine providing, to a user of client device 102, access to a computing environment. Client device 102 may be a virtual machine. The virtual machine may be managed by, for example, a hypervisor, a virtual machine manager (VMM), or any other hardware virtualization technique within server 106.

In some embodiments, network 104 may be: a local-area network (LAN); a metropolitan area network (MAN); a wide area network (WAN); a primary public network; and a primary private network. Additional embodiments may include a network 104 of mobile telephone networks that use various protocols to communicate among mobile devices. For short range communications within a wireless local-area network (WLAN), the protocols may include 802.11, Bluetooth, and Near Field Communication (NFC).

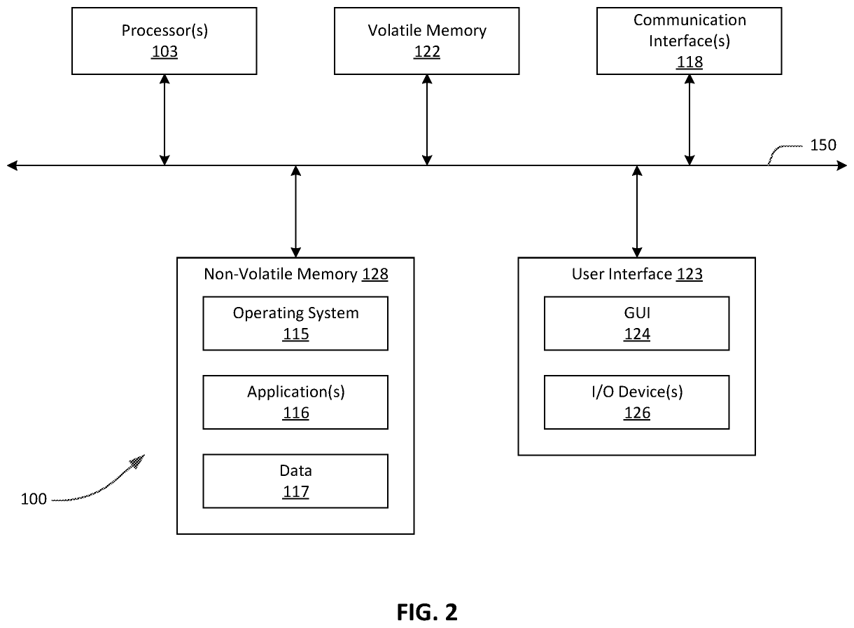

FIG. 2 is a block diagram illustrating selective components of an illustrative computing device 100 in which various aspects of the disclosure may be implemented, in accordance with an embodiment of the present disclosure. For instance, client devices 102, appliances 108, and/or servers 106 of FIG. 1 can be substantially similar to computing device 100. As shown, computing device 100 includes one or more processors 103, a volatile memory 122 (e.g., random access memory (RAM)), a non-volatile memory 128, a user interface (UI) 123, one or more communications interfaces 118, and a communications bus 150.

Non-volatile memory 128 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

User interface 123 may include a graphical user interface (GUI) 124 (e.g., a touchscreen, a display, etc.) and one or more input/output (I/O) devices 126 (e.g., a mouse, a keyboard, a microphone, one or more speakers, one or more cameras, one or more biometric scanners, one or more environmental sensors, and one or more accelerometers, etc.).

Non-volatile memory 128 stores an operating system 115, one or more applications 116, and data 117 such that, for example, computer instructions of operating system 115 and/or applications 116 are executed by processor(s) 103 out of volatile memory 122. In some embodiments, volatile memory 122 may include one or more types of RAM and/or a cache memory that may offer a faster response time than a main memory. Data may be entered using an input device of GUI 124 or received from I/O device(s) 126. Various elements of computing device 100 may communicate via communications bus 150.

The illustrated computing device 100 is shown merely as an illustrative client device or server and may be implemented by any computing or processing environment with any type of machine or set of machines that may have suitable hardware and/or software capable of operating as described herein.

Processor(s) 103 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

Processor 103 may be analog, digital or mixed signal. In some embodiments, processor 103 may be one or more physical processors, or one or more virtual (e.g., remotely located or cloud computing environment) processors. A processor including multiple processor cores and/or multiple processors may provide functionality for parallel, simultaneous execution of instructions or for parallel, simultaneous execution of one instruction on more than one piece of data.

Communications interfaces 118 may include one or more interfaces to enable computing device 100 to access a computer network such as a Local Area Network (LAN), a Wide Area Network (WAN), a Personal Area Network (PAN), or the Internet through a variety of wired and/or wireless connections, including cellular connections.

In described embodiments, computing device 100 may execute an application on behalf of a user of a client device. For example, computing device 100 may execute one or more virtual machines managed by a hypervisor. Each virtual machine may provide an execution session within which applications execute on behalf of a user or a client device, such as a hosted desktop session. Computing device 100 may also execute a terminal services session to provide a hosted desktop environment. Computing device 100 may provide access to a remote computing environment including one or more applications, one or more desktop applications, and one or more desktop sessions in which one or more applications may execute.

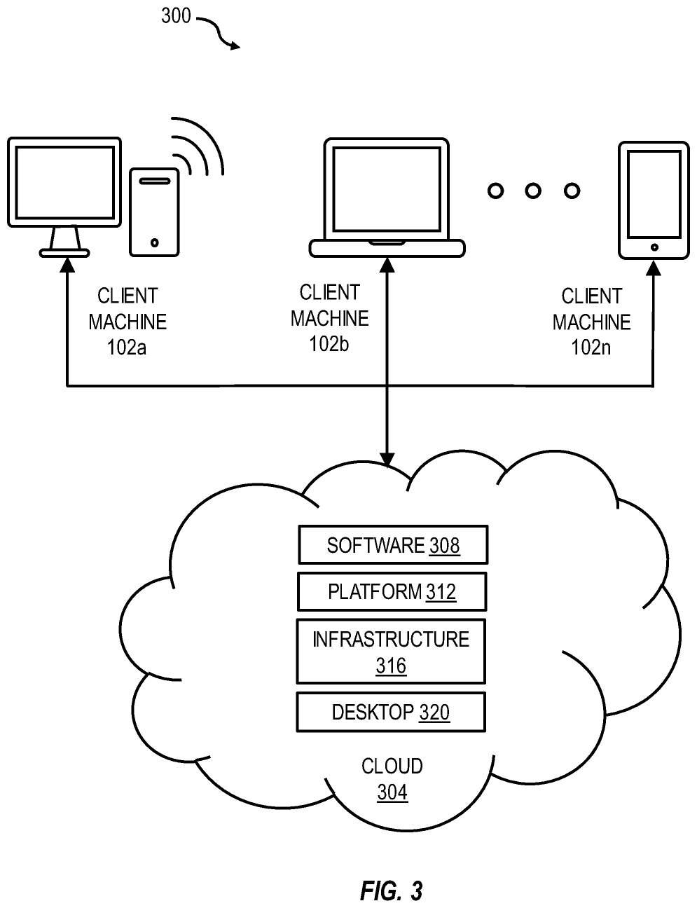

Referring to FIG. 3, a cloud computing environment 300 is depicted, which may also be referred to as a cloud environment, cloud computing or cloud network. Cloud computing environment 300 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In cloud computing environment 300, one or more clients 102a-102n (such as those described above) are in communication with a cloud network 304. Cloud network 304 may include back-end platforms, e.g., servers, storage, server farms or data centers. The users or clients 102a-102n can correspond to a single organization/tenant or multiple organizations/tenants. More particularly, in one illustrative implementation, cloud computing environment 300 may provide a private cloud serving a single organization (e.g., enterprise cloud). In another example, cloud computing environment 300 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, cloud computing environment 300 may provide a hybrid cloud that is a combination of a public cloud and a private cloud. Public clouds may include public servers that are maintained by third parties to clients 102a-102n or the enterprise/tenant. The servers may be located off-site in remote geographical locations or otherwise.

Cloud computing environment 300 can provide resource pooling to serve multiple users via clients 102a-102n through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, cloud computing environment 300 can provide on-demand self-service to unilaterally provision computing capabilities (e.g., server time, network storage) across a network for multiple clients 102a-102n. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. Cloud computing environment 300 can provide an elasticity to dynamically scale out or scale in response to different demands from one or more clients 102. In some embodiments, cloud computing environment 300 can include or provide monitoring services to monitor, control and/or generate reports corresponding to the provided shared services and resources.

In some embodiments, cloud computing environment 300 may provide cloud-based delivery of different types of cloud computing services, such as Software as a service (SaaS) 308, Platform as a Service (PaaS) 312, Infrastructure as a Service (IaaS) 316, and Desktop as a Service (DaaS) 320, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g., Citrix ShareFile from Citrix Systems, DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure such as AZURE CLOUD from Microsoft Corporation of Redmond, Wash. (herein “Azure”), or AMAZON WEB SERVICES provided by Amazon.com, Inc., of Seattle, Wash. (herein “AWS”), for example. In the case of Citrix Cloud, Citrix Workspace app may be used as a single-entry point for bringing apps, files and desktops together (whether on-premises or in the cloud) to deliver a unified experience.

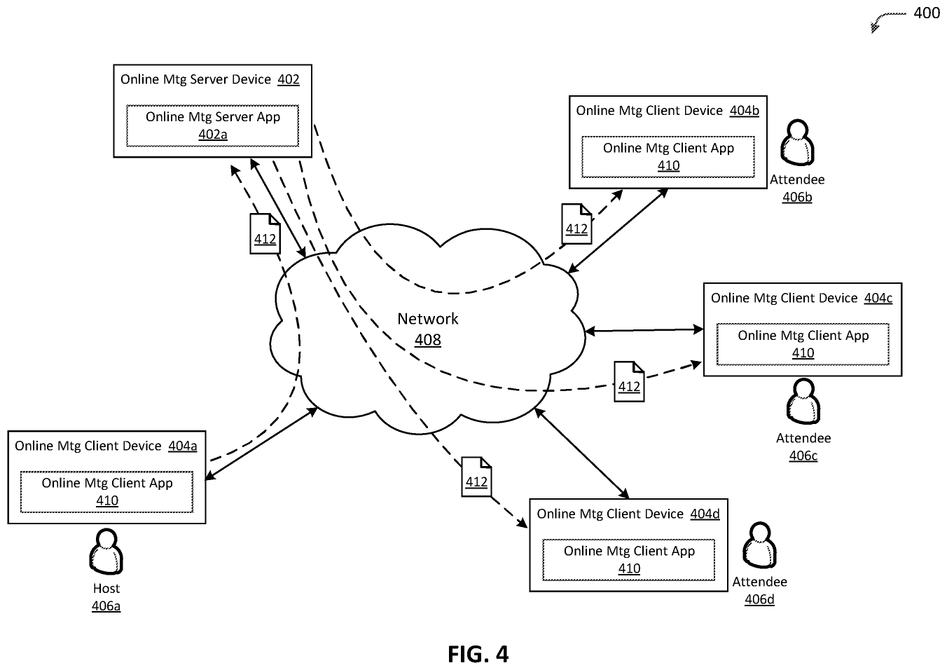

FIG. 4 is a block diagram of an example online meeting system 400 that can be used to provide screen sharing, in accordance with an embodiment of the present disclosure. As shown, online meeting system 400 can include an online meeting server device 402 communicatively coupled to online meeting client devices 404a-404d (sometimes referred to herein more simply as “client devices 404” or “client device 404” in the singular form) via a network 408. Network 408 can be a local area network, a wide area network, the Internet, and/or other wired or wireless networks. For example, in some implementations, network 408 may correspond to network 104 described previously.

The number of client devices 404 depicted in online meeting system 400 is for illustration, and those skilled in the art will appreciate that there may be a different number of client devices 404, including very large numbers of client devices 404. Also, in some implementations, online meeting system 400 may not have all of the elements shown in FIG. 4 and/or may have other elements including other types of elements instead of, or in addition to, some or all of the elements shown in FIG. 4. For example, online meeting system 400 may include more than one online meeting server device 402.

Still referring to online meeting system 400 of FIG. 4, online meeting server device 402 (sometimes referred to herein more simply as “server device 402”) may provide collaboration and communication functionality to enable online meetings to occur between meeting attendees at various locations. For example, users can use computing devices (e.g., client devices 404) to join and attend an online meeting being hosted by server device 402. To this end, server device 402 can include an online meeting server application 402a (sometimes referred to herein more simply as “server application 402a”) that may be configured to implement certain of the functionalities disclosed herein, including receiving meeting content from a client device 404 over a network connection, processing the received meeting content, and retransmitting the processed meeting content to appropriate client devices 404 via network 408 over one or more network connections. It may thus be said that server device 402, and online meeting server application 402a in particular, links together the online meeting endpoints (i.e., by transmitting meeting content between online meeting endpoints via network 408) and thus enables online meetings (online conferencing) to occur between meeting attendees.

Each client device 404 may have installed thereon an online meeting client application 410 (sometimes referred to herein more simply as “client application 410”). Client application 410 may be configured to execute on client device 404 and access and utilize the services and functionality made available by server application 402a on server device 402. For example, a user of client device 404 may use client application 410 to access server application 402a on server device 402 and participate (e.g., schedule, join, host, attend, etc.) in an online meeting as variously described herein.

Client device 404 can include smartphones, tablet computers, laptop computers, desktop computers, or other computing devices configured to run user applications (or “apps”). In some embodiments, client device 404 may be substantially similar to client machine 102 described above in the context of FIGS. 1 and 3 and/or computing device 100 described above in the context of FIG. 2.

As a solution to the aforementioned and other technical problems related to screen sharing over low or insufficient bandwidth network connections, in some embodiments, server application 402a may be configured to distribute content that is to be shared (i.e., presented) during an online meeting to meeting attendees prior to the start of the online meeting. The content may be included or otherwise contained in one or more files, such as document files, presentation files, image files, and/or video files, among others. Once the file(s) containing the content are distributed to the meeting attendees, the content can be shared with the meeting attendees during the online meeting without having to send a video of the content being shared to the respective computing devices being used by the meeting attendees to attend the online meeting. For example, when a presenter in the online meeting shares contents of a file that is being displayed on the presenter's screen (i.e., a screen of the presenter's computing device), the presenter's computing device can detect a change in the state of the file and send a state change command informing of the detected state change to server application 402a. Upon receiving the state change command, server application 402a can send the state change command to the computing devices of the online meeting attendees, which executes the state change command causing the rendering of the content that is being shared by the meeting presenter on the screens of the computing devices of the meeting attendees.

With continued reference to FIG. 4, in an example scenario and embodiment, a meeting host 406a can use client application 410 on client device 404a to schedule an online meeting with one or more meeting attendees such as, for example, meeting attendees 406b, 406c, 406d. When scheduling the online meeting, along with providing the needed meeting information (e.g., a scheduled date and time for the meeting, a meeting duration, a list of meeting attendees to be invited to the meeting, etc.), meeting host 406a can specify an encrypted file 412. Encrypted file 412 is a protected file (e.g., protected via encryption) that contains the content that is to be shared with the meeting attendees during the online meeting. Alternatively, meeting host 406a may specify a file that contains the content that is to be shared, which may then be encrypted by client application 410 or server application 402. Meeting host 406a can then complete or otherwise finish the scheduling of the online meeting, causing client application 410 on client device 404a to send or otherwise provide the scheduled online meeting details and encrypted file 412 to server application 402a on server device 402. Note that only one encrypted file is specified in the example above for purposes of clarity, and that meeting host 406a can specify any number of files which contain content that is to be shared. In such cases, it will be appreciated that encrypted file 412 can be multiple (i.e., one or more) encrypted files or an encrypted archive of the files.

In response to receiving the scheduled online meeting details, server application 402a can send an invite to the individual meeting attendees who are to be invited to the online meeting. The invite can carry or otherwise include invite data which allows the invited meeting attendee to join the online meeting. Then, in response to an invited meeting attendee accepting the invite, server application 402a can send encrypted file 412 (i.e., the content that is to be shared during the online meeting) to the meeting attendee.

Continuing the above example, server application 402a can send an invitation of the scheduled online meeting to the individual meeting attendees 406b, 406c, 406d. For example, the invite may be in the form of an email. Meeting attendee 406b can then use client device 404b to view and accept the invitation, causing client device 404b to send a notification of the acceptance of the invitation by meeting attendee 406b to server application 402a. In some embodiments, meeting attendee 406b can use client application 410 on client device 404b to view and/or accept the invitation. In any case, in response to receiving the notification from client device 404b, server application 402a can download encrypted file 412 to client device 404b. Similarly, meeting attendee 406c can use client device 404c to view and accept the invitation, causing server application 402a to download encrypted file 412 to client device 404c, and meeting attendee 406d can use client device 404d to view and accept the invitation, causing server application 402a to download encrypted file 412 to client device 404d. Downloading encrypted files in this manner protects and secures the data contained in the files from being compromised at least prior to the online meeting during which time the encrypted files are decrypted, as will be further described below. Thus, the meeting invitee is prevented from accessing contents of the encrypted files prior to a start of the online meeting.

In some embodiments, the invitation may include or otherwise contain encrypted file 412. In such embodiments, there is no need for server application 402a to download encrypted file 412 in response to an invited meeting attendee accepting the invitation of the scheduled online meeting.

At the scheduled time of the online meeting, meeting host 406a can use client application 410 on a suitable computing device (e.g., client device 404a) to access server application 402a and start the online meeting. Once the online meeting is started, client application 410 on client device 404a can send a decryption key that is configured to decrypt encrypted file 412 to server application 402a on server device 402. The sending of the decryption key may take place in response to the online meeting being started. Alternatively, the sending of the decryption key may take place in response to a command from meeting host 406a directing client application 410 on client device 404a to send the decryption key. Server application 402a can then send the decryption key provided by client application 410 on client device 404a to the individual meeting attendees. For example, server application 402a may be configured to send the decryption key to a meeting attendee upon the meeting attendee joining the online meeting.

Continuing the above example, meeting attendee 406b can use client application 410 on a suitable computing device (e.g., client device 404b) to join the online meeting. Upon meeting attendee 406b joining the online meeting, server application 402a can send the decryption key to client application 410 on client device 404b. Client application 410 can then use the decryption key to decrypt the local copy of encrypted file 412 which was previously downloaded onto client device 404b to generate a local copy of decrypted encrypted file 412 on client device 404b. Similarly, meeting attendee 406c can use client application 410 on a suitable computing device (e.g., client device 404c) to join the online meeting, causing server application 402a to send the decryption key to client application 410 on client device 404c. Client application 410 can then use the decryption key to decrypt the local copy of encrypted file 412 which was previously downloaded onto client device 404c to generate a local copy of decrypted encrypted file 412 on client device 404c. Likewise, meeting attendee 406d can use client application 410 on a suitable computing device (e.g., client device 404d) to join the online meeting, causing server application 402a to send the decryption key to client application 410 on client device 404d. Client application 410 can use the decryption key to decrypt the local copy of encrypted file 412 which was previously downloaded onto client device 404d to generate a local copy of decrypted encrypted file 412 on client device 404d. The decrypting of the local copy of encrypted file 412 may take place in response to client application 410 receiving the decryption key. Alternatively, the decrypting of encrypted file 412 may take place in response to a command from the meeting attendee directing client application 410 to decrypt encrypted file 412 using the decryption key. Once decrypted, the contents of encrypted file 412 become available for use during the online meeting by the individual online meeting client applications 410 that are being used by the meeting attendees to participate in the online meeting.

Note that, during an online meeting, the capability exists for any online meeting client device that is being used to participate in the online meeting to be a presenter client device. For example, at the start of an online meeting, the online meeting client device that is being used by meeting host 406a may become the meeting presenter client device. The capability exists for an online meeting client device that is being used by a meeting attendee (e.g., meeting attendee 406b, 406c, or 406d) to become the new meeting presenter client device, and for the prior meeting presenter client device to become a meeting attendee client device. During such a transition, the meeting attendee who is using the new meeting presenter client device becomes the new presenter, and the prior presenter becomes a meeting attendee (i.e., one of the meeting attendees). Note that there can be at most one presenter at any time during the online meeting.

Once the online meeting is started, client application 410 executing on the meeting presenter client device may be configured to detect a change in a state of the decrypted encrypted file 412 and/or the contents of the decrypted encrypted file 412 and, in response to detecting a state change, send a state change command to server application 402a. Here, the state change command is a specific instruction to perform some operation (e.g., task or function) on the decrypted encrypted file 412 to reproduce the detected state change. For example, suppose the state change that is detected is the opening of the decrypted encrypted file 412 (i.e., the decrypted encrypted file 412 changing from being a closed file to an open file). In this case, the state change command can be an instruction to open the decrypted encrypted file 412. As another example, suppose the decrypted encrypted file 412 is a video file and the state change that is detected is the playing/stopping/pausing/rewinding/etc. of the video data in the decrypted encrypted file 412. In this case, the state change command can be an instruction to play/stop/pause/rewind/etc. the video data in the decrypted encrypted file 412. As another example, suppose the decrypted encrypted file 412 is a presentation file and the state change that is detected is the changing (e.g., moving or presenting) to a next slide in a slide deck. In this case, the state change command can be an instruction to change to the next slide in the slide deck in the decrypted encrypted file 412. As another example, suppose the decrypted encrypted file 412 is a document file and the state change that is detected is the navigating to a specific page of the document in the decrypted encrypted file 412. In this case, the state change command can be an instruction to navigate to the specific page of the document in the decrypted encrypted file 412. In any case, the state change command can be executed on a computing device to reproduce on that computing device the state of the decrypted encrypted file 412 which was detected on the meeting presenter client device. It will be appreciated that the state changes that are detected by client application 410 may depend on the type of file (e.g., text document file, presentation file, video file, audio file, etc.).

In response to receiving the state change command, server application 402a can send the state change command to each of the meeting attendee client devices. A client application 410 on each meeting attendee client device can then execute the state change command on the previously downloaded and decrypted encrypted file 412 (i.e., the local copy of decrypted encrypted file 412) to reproduce on that meeting attendee client device the state of the decrypted encrypted file 412 which was detected on the meeting presenter client device. In some embodiments, the meeting attendee client device can render the state change (e.g., the changed content of the decrypted encrypted file 412) on a screen of the meeting attendee client device. Rendering the content in this manner allows the meeting attendees to view on their respective meeting attendee client devices the content of the decrypted encrypted file 412 that is being displayed on the meeting presenter client device.

Continuing the above example, during the online meeting, meeting host 406a can use client application 410 on client device 404a to activate a screen share feature and open the decrypted encrypted file 412 to share (i.e. present) the contents of the file with the other meeting attendees. A screen share feature is a feature where a meeting attendee (referred to as a meeting presenter) shares content being displayed on the meeting presenter's screen, or a selected portion or portions of the meeting presenter's screen, such that other meeting attendees in the online meeting can see the shared content on the screens of their computing devices (e.g., the screens of meeting attendee computing devices). When meeting host 406a opens the decrypted encrypted file 412, client application 410 on client device 404a can detect the change in the state of the decrypted encrypted file 412 and generate a state change command, which, in this case, is an instruction to open the decrypted encrypted file 412. Client application 410 on client device 404a can then send the state change command to server application 402a on server device 402.

In response to receiving the state change command, server application 402a can send the state change command to client application 410 on client device 404b, client application 410 on client device 404c, and client application 410 on client device 404d. In response to receiving the state change command, client application 410 on client device 404b can execute the state change command on the local copy of decrypted encrypted file 412 to open the decrypted encrypted file 412 on client device 404b. Similarly, client application 410 on client device 404c can execute the state change command on the local copy of decrypted encrypted file 412 to open the decrypted encrypted file 412 on client device 404c, and client application 410 on client device 404d can execute the state change command on the local copy of decrypted encrypted file 412 to open the decrypted encrypted file 412 on client device 404d. As a result of executing the state change command, the state of the decrypted encrypted file 412 (e.g., file opened) is the same on client device 404a (the meeting presenter client device) and client devices 404b, 404c, 404d (the meeting attendee client devices).

With continued reference to the above example, supposing the decrypted encrypted file 412 is a document, meeting host 406a can use client application 410 and display page 2 of the document on a screen of client device 404a to share the contents on page 2 of the document with the other meeting attendees. When meeting host 406a displays page 2 of the document on the screen of client device 404a, client application 410 on client device 404a can detect the change in the state of the decrypted encrypted file 412 and generate a state change command, which, in this case, is an instruction to display page 2 of the document. Client application 410 on client device 404a can then send the state change command (the instruction to display page 2 of the document) to server application 402a on server device 402.

In response to receiving the state change command (the instruction to display page 2 of the document), server application 402a can send the state change command to client application 410 on client device 404b, client application 410 on client device 404c, and client application 410 on client device 404d. In response to receiving the state change command, client application 410 on client device 404b can execute the state change command on the local copy of decrypted encrypted file 412 to display page 2 of the document and render page 2 of the document on a screen of client device 404b. Similarly, client application 410 on client device 404c can execute the state change command on the local copy of decrypted encrypted file 412 to display page 2 of the document and render page 2 of the document on a screen of client device 404c, and client application 410 on client device 404d can execute the state change command on the local copy of decrypted encrypted file 412 to display page 2 of the document and render page 2 of the document on a screen of client device 404d. As a result of executing the state change command, the state of the decrypted encrypted file 412 (e.g., page 2 of the document is displayed) is the same on client device 404a (the meeting presenter client device) and client devices 404b, 404c, 404d (the meeting attendee client devices).

In some cases, online meeting server application 402a may send a video of the content that is being shared to a meeting attendee client device instead of the state change command. For example, a meeting attendee may be using a client device that does not have a local copy of the previously downloaded content (e.g., encrypted file 412). This may be the case if the meeting attendee is using a client device that is different from the computing device used to accept the meeting invite and onto which the content was previously downloaded by server application 402a. Or, the meeting attendee may be using the same client device but, for some reason, the previously downloaded content is not available on the client device. Or, the meeting attendee may be attending the meeting using an unsupported browser or other client application that is not able to execute the state change command. In any case, online meeting server application 402a may deliver a video stream of the content that is being shared by the meeting presenter to the meeting attendee who is attending the meeting using a client device unable to support (e.g., execute) the state change command.

To support such meeting attendees (i.e., meeting attendee client devices), according to one embodiment, server application 402a may be configured to execute a state change command on a local copy of the decrypted encrypted file (e.g., the local copy of decrypted encrypted file 412) in response to receiving the state change command from the meeting presenter client device. As previously explained, server application 402a would have previously received the encrypted file that contains the content that is to be shared (e.g., encrypted file 412) prior to the start of the online meeting, and the decryption key at the start of the online meeting. At the time of receiving the encrypted file, server application 402a may have generated a local copy of the encrypted file on server device 402. Thus, server application 402a can use the decryption key to decrypt the local copy of the encrypted file to generate a local copy of the decrypted encrypted file on server device 402. Then, in response to receiving a state change command, server application 402a can execute the state change command on the local copy of the decrypted encrypted file and render the state change (e.g., the changed content of the decrypted encrypted file) on server device 402. The rendered content is the same as the content that is being displayed on the meeting presenter client device and which is being shared by the meeting presenter. Server application 402a can then generate a video of the rendered state change and send the video (e.g., a video stream) of the rendered state change to an unsupported meeting attendee client device for rendering of the video stream on a screen of the unsupported meeting attendee client device. As a result, the meeting attendee who is attending the meeting using the unsupported meeting attendee client device is able to view the content that is being shared by the meeting presenter.

In some embodiments, at the conclusion of an online meeting, the local copy of the file(s) that contain the content that was provided by the meeting host to be shared during the online meeting are deleted (e.g., wiped) from the computing devices other than the meeting host's computing device. To this end, the online meeting server application (e.g., server application 402a on server device 402) may be configured to delete the local copy of the file(s) provided by a meeting host for sharing during an online meeting (e.g., encrypted file 412) at the conclusion of the online meeting. Similarly, the online meeting client application on each meeting attendee client device may be configured to delete the local copy of the file(s) downloaded by or from the online meeting server application for sharing during an online meeting (e.g., encrypted file 412) at the conclusion of the online meeting. In both cases, the local copy of the content (e.g., the local copy of the encrypted file(s) containing the content and/or the decrypted encrypted file(s)) is deleted such that a computing device (e.g., server device 402 and/or client device 404) used to receive, process, and/or view the content no longer contains any trace of ever having received the content. In cases where the content is stored on the computing device, the content is deleted from anywhere it can be stored, such as from memory associated with the computing device. Ideally, the content is deleted such that the computing devices no longer contain any trace of ever having received, processed, and/or stored the content.

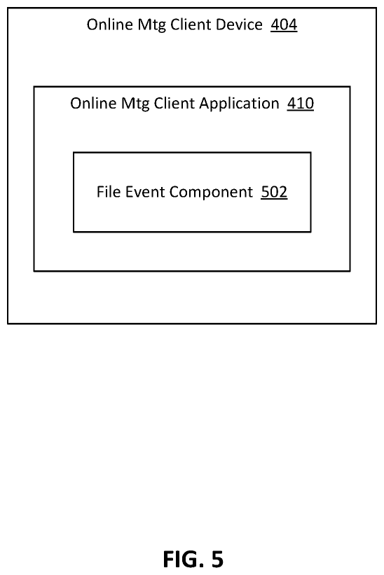

Referring now to FIG. 5, in some embodiments, client application 410 can include a file event component 502 that is configured to detect changes in the state of a file that is being shared, generate a state change command for a detected state change, and execute state change commands. To this end, file event component 502 may be implemented utilizing a software development kit (SDK) for developing applications for a specific platform. An SDK is a set of tools which can be used to develop a custom application that can be added on and/or connected to another application supported by the specific platform. For example, an ANDROID® SDK may be used to develop a custom application to interact with an ANDROID® application, an IOS® SDK may be used to develop a custom application to interact with an IOS® application, a MICROSOFT® WINDOWS® SDK may be used to develop a custom application to interact with a WINDOWS® application, and so on. Thus, a MICROSOFT® WINDOWS® SDK can be used to develop an application to detect and/or track events which occur within a WINDOWS® application such as MICROSOFT® Word, MICROSOFT® POWERPOINT®, and MICROSOFT® Excel, among others.

Implemented in such as manner (i.e., utilizing SDK(s)), file event component 502 is not limited to a specific application, but can detect and/or track events which occur within multiple applications. For example, file event component 502 may be configured to utilize a MICROSOFT® WINDOWS® SDK to detect a change in the state of a MICROSOFT® Word file, a MICROSOFT® POWERPOINT® file, a MICROSOFT® Excel file, and/or any one or more other types of files supported by the WINDOWS® platform. Similarly, file event component 502 may be configured to utilize any of the other platform SDKs to detect a change in the state of any one or more application files that are supported by that platform. It will be appreciated that an SDK in this context also alludes to a framework that provides a feature set and, in some cases a significant feature set, that a host application can leverage.

Upon detecting a change in the state of a file, file event component 502 can generate a state change command corresponding to the detected state change of the file. The state change command may be executed using the file to reproduce the detected state change of the file. File event component 502 can then send the generated state change command to client application 410 for sending to an online meeting server application (e.g., server application 402a on server device 402).

In some embodiments, file event component 502 may be configured to execute state change commands. For example, file event component 502 may be executing on a meeting attendee client device, and a state change command sent by an online meeting server application (e.g., server application 402a on server device 402) may be received by the meeting attendee client device. In response to receiving the state change command, file event component 502 can execute the state change command on a local copy of the file to reproduce the state of the file (e.g., open file, close file, display a specific page, change to a next slide, etc.). File event component 502 can then send the results of the executed state change command (i.e., resulting state change to the file) to client application 410 for rendering on a screen of the meeting attendee client device.

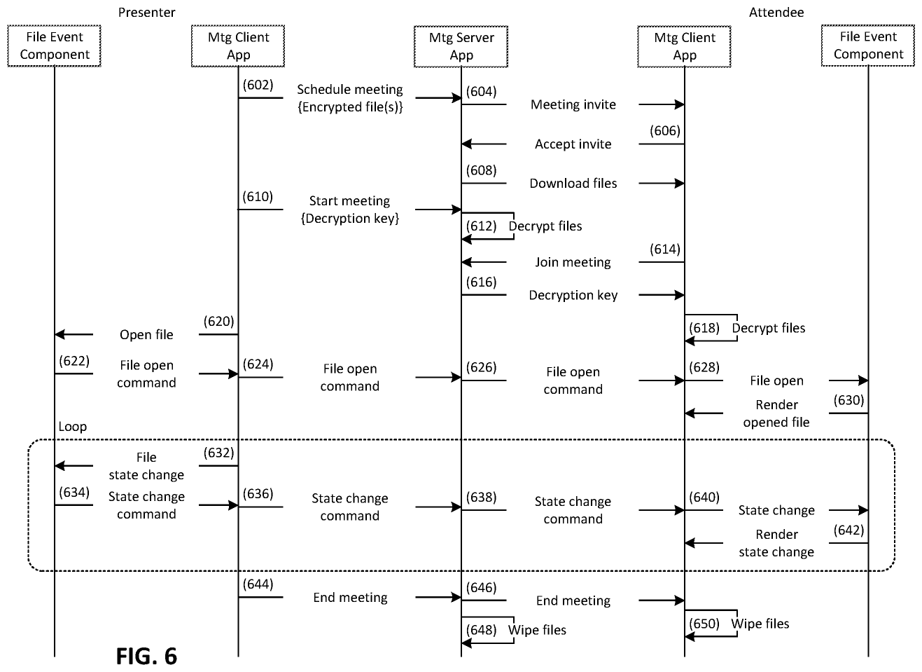

FIG. 6 is a sequence diagram showing an example flow of interactions between various components to perform screen sharing during an online meeting, in accordance with an embodiment of the present disclosure. For example, with reference to the elements illustrated in FIGS. 4 and 5, meeting host 406a may want to share some content as a meeting presenter during a yet-to-be scheduled online meeting. To do so, meeting host 406a may use client application 410 on client device 404a to schedule an online meeting with a meeting attendee (e.g., meeting attendee 406b). For example, meeting host 406a may provide inputs, such as keyboard inputs and/or mouse inputs, to client application 410 on client device 404a to schedule the online meeting. When scheduling the online meeting, meeting host 406a may also specify one or more encrypted files (e.g., encrypted file(s) 412) which contain the content that is to be shared during the online meeting. While only one meeting attendee is included in the example above for purposes of clarity, it will be appreciated that the online meeting can include any number of meeting attendees. In other words, a meeting host may invite any number of meeting attendees to an online meeting.

In response to the provided input, client application 410 on client device 404a may send (602) a request to schedule the online meeting to server application 402a on server device 402. The request include may include the online meeting details specified by meeting host 406a, including the one or more encrypted file(s) (e.g., encrypted file(s) 412). In response to the request, server application 402a may generate and send (604) an invitation of the scheduled online meeting (e.g., a meeting invite) to meeting attendee 406b. In some embodiments, server application 402a may maintain a local copy of the one or more encrypted files, for example, on server device 402.

Upon receiving a notification of the meeting invite, meeting attendee 406b may use a suitable client application (e.g., client application 410) on client device 404b to view and accept the meeting invitation. For example, meeting attendee 406b may provide an input, such as a keyboard input and/or a mouse input, to client application 410 on client device 404b to accept the meeting invitation. In response to the provided input, client application 410 on client device 404b may send (606) a notification informing of the acceptance of the invitation by meeting attendee 406b to server application 402a. In response to this notification from client application 410 on client device 404b, server application 402a may download (608) the one or more encrypted file(s) 412 to client application 410 on client device 404b for local storage on client device 404b.

At the scheduled time of the online meeting, meeting host 406a may use client application 410 on client device 404a to access server application 402a to start the online meeting. For example, meeting host 406a may provide an input, such as a keyboard input and/or a mouse input, to client application 410 on client device 404a to start the online meeting. In response to the provided input, client application 410 on client device 404a may send (610) a request to start the online meeting to server application 402a. In some embodiments, client application 410 on client device 404a may include with the request a decryption key that is configured to decrypt the one or more encrypted file(s) 412 that were previously sent for use during the online meeting. In response to the request, server application 402a may start the scheduled online meeting. In some embodiments, server application 402a may use the decryption key to decrypt (612) the local copy of the one or more encrypted file(s) 412 on server device 402.

Still referring to FIG. 6, server application 402a may receive (614) a request to join the online meeting from meeting attendee 406b. For example, meeting attendee 406b may provide an input, such as a keyboard input and/or a mouse input, to client application 410 on client device 404b to join the online meeting, causing client application 410 on client device 404b to send the request to server application 402a. In response to receiving the request, server application 402a may send (616) the decryption key to client application 410 on client device 404b. Upon receiving the decryption key, client application 410 on client device 404b may use the decryption key to decrypt (618) the local copy of the one or more encrypted file(s) 412 on client device 404b. As a result, the content to be shared during the online meeting (i.e., the decrypted one or more encrypted file(s) 412) is available for use by client application 410 and, in particular, file event component 502 of client application 410 on client device 404b.

During the online meeting, meeting host 406a, as a meeting presenter, may use client application 410 on client device 404a to open (620) one of the one or more encrypted file(s) 412 to share (i.e., present) the content from the opened file. For example, meeting host 406a may provide inputs, such as keyboard inputs and/or mouse inputs, to client application 410 on client device 404a to activate a screen sharing feature and open the file for screen sharing. Note that the one or more encrypted file(s) 412 is decrypted using the decryption key prior to the opening of the file. When meeting host 406a opens the file, file event component 502 of client application 410 on client device 404a may detect a change in a state of the opened file (e.g., the state of the file changing from being a closed file to an opened file). In response to detecting the state change of the file to be an opened file, file event component 502 of client application 410 may send (622) a file open command to its client application 410 (i.e., client application 410 on client device 404a). For example, according to one embodiment, the file open command may be a file open callback that can be called to execute the opening of the file. In some such embodiments, client application 410 on client device 404a may execute the file open callback to open the file. In response to receiving the file open command, client application 410 on client device 404a may send (624) the file open command to server application 402a.

In response to receiving the file open command, server application 402a may send (626) the file open command to client application 410 on client device 404b. In some embodiments, server application 402a may execute the file open command on the local copy of the decrypted file on server device 402 to open the file (e.g., open the local copy of the decrypted encrypted file 412 on server device 402).

In response to receiving the file open command, file event component 502 of client application 410 on client device 404b may execute (628) the file open command on the local copy of the decrypted file on client device 404b (e.g., open the local copy of the decrypted encrypted file 412 on client device 404b). File event component 502 may then send (630) a notification of the execution of the file open command (e.g., a notification of the rendered open file) its client application 410 (i.e., client application 410 on client device 404b).

With continued reference to FIG. 6, once the file is opened, meeting host 406a may use client application 410 on client device 404a and perform an action on the opened file to share its contents. For example, meeting host 406a may perform the action by providing an input, such as a keyboard input and/or a mouse input, to client application 410 on client device 404a. The performed action may cause a change in the state of the opened file which may be detected (632) by file event component 502 of client application 410 on client device 404a. In response to detecting the state change to the opened file, file event component 502 of client application 410 may generate a state change command corresponding to the detected state change to the opened file. File event component 512 may then send (634) the generated state change command to its client application 410 (i.e., client application 410 on client device 404a). In response to receiving the state change command, client application 410 on client device 404a may send (636) the state change command to server application 402a.

In response to receiving the state change command, server application 402a may send (638) the state change command to client application 410 on client device 404b. In some embodiments, server application 402a may execute the state change command on the local copy of the decrypted file on server device 402. Execution of the state change command may generate a rendering of the state change to the file (e.g., rendering of the changed content) on server device 402.

In response to receiving the state change command, file event component 502 of client application 410 on client device 404b may execute (640) the state change command on the local copy of the decrypted file on client device 404b. File event component 502 may then send (642) a request to render the changed content resulting from the execution of the state change command to its client application 410 (i.e., client application 410 on client device 404b). In response to the request, client application 410 on client device 404b may render the changed content on a screen of client device 404b.

Interactions 632-642 may be repeated as necessary to process further actions performed by meeting host 406a (e.g., the meeting presenter) to share the contents of the opened file during the online meeting.

Still referring to FIG. 6, meeting host 406a may use client application 410 on client device 404a to close the online meeting. For example, meeting host 406a may provide an input, such as a keyboard input and/or a mouse input, to client application 410 on client device 404a to close the online meeting. In response to the provided input, client application 410 on client device 404a may send (644) a request to end the online meeting to server application 402a. In response to the request, server application 402a may end the online meeting and send (646) a notification of the ending of the online meeting to client application 410 on client device 404b.

In some embodiments, in response to receiving the request to end the online meeting, server application 402a may delete (e.g., wipe) (648) the local copy of the one or more encrypted files (e.g., encrypted file(s) 412) which were provided by meeting host 406a for sharing during the online meeting. In some embodiments, upon receiving the notification of the ending of the online meeting, client application 410 on client device 404b may delete (e.g., wipe) (650) the local copy of the one or more encrypted files (e.g., encrypted file(s) 412) which were downloaded by server application 402a for sharing during the online meeting.

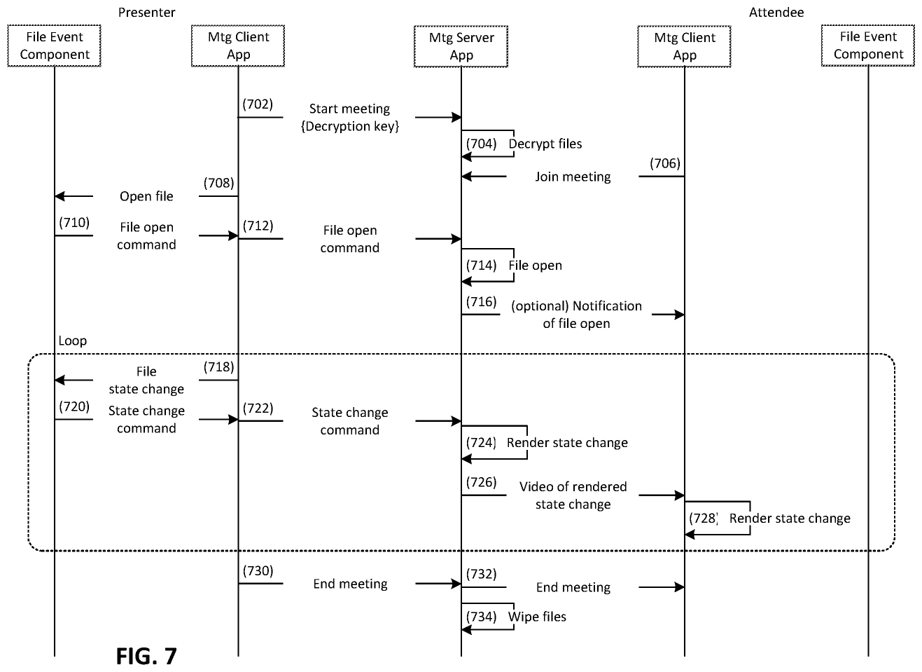

FIG. 7 is a sequence diagram showing an example flow of interactions between various components to perform screen sharing during an online meeting, in accordance with an embodiment of the present disclosure. In particular, the interactions shown in FIG. 7 may be performed to provide screen sharing for a client device that is unable to support (e.g., execute) the state change command. For example, with reference to the elements illustrated in FIGS. 4 and 5, it is assumed that meeting host 406a has scheduled an online meeting with meeting attendee 406b, meeting host 406a has provided the content to be shared during the online meeting (e.g., one or more encrypted file(s) 412) to server application 402a on server device 402, server application 402a has sent an invitation of the scheduled online meeting (e.g., a meeting invite) to meeting attendee 406b, meeting attendee 406b has accepted the meeting invitation using client application 410 on client device 404b, and server application 402a has download (608) the one or more encrypted file(s) 412 to client application 410 on client device 404b (e.g., interactions 602-608 od FIG. 6).

With reference to FIG. 7, at the scheduled time of the online meeting, meeting host 406a may use client application 410 on client device 404a to access server application 402a to start the online meeting. For example, meeting host 406a may provide an input, such as a keyboard input and/or a mouse input, to client application 410 on client device 404a to start the online meeting. In response to the provided input, client application 410 on client device 404a may send (702) a request to start the online meeting to server application 402a. In some embodiments, client application 410 on client device 404a may include with the request a decryption key that is configured to decrypt the one or more encrypted file(s) 412 that were previously sent for use during the online meeting.

In response to the request, server application 402a may start the scheduled online meeting. Upon starting the meeting, server application 402a may use the decryption key to decrypt (704) the local copy of the one or more encrypted file(s) 412 on server device 402.

Server application 402a may receive (706) a request to join the online meeting from meeting attendee 406b. For example, meeting attendee 406b may provide an input, such as a keyboard input and/or a mouse input, to a client application on a client device, which may be a client device other than client device 404b, to join the online meeting. In response to the provided input, the client application may send the request to server application 402a. Upon receiving the request from meeting attendee 406b to join the online meeting, server application 402a may determine that meeting attendee 406b is using a client device that is unable to support (e.g., execute) the state change commands. Based on this determination, server application 402a may not send the decryption key but, instead, determine that a video of the of the content of the one or more encrypted file(s) 412 is to be sent to meeting attendee 406b.

Still referring to FIG. 7, during the online meeting, meeting host 406a, as a meeting presenter, may use client application 410 on client device 404a to open (708) one of the one or more encrypted file(s) 412 to share (i.e., present) the content from the opened file. For example, meeting host 406a may provide inputs, such as keyboard inputs and/or mouse inputs, to client application 410 on client device 404a to activate a screen sharing feature and open the file for screen sharing. When meeting host 406a opens the file, file event component 502 of client application 410 on client device 404a may detect a change in a state of the opened file (e.g., the state of the file changing from being a closed file to an opened file). In response to detecting the state change of the file to be an opened file, file event component 502 of client application 410 may send (710) a file open command to its client application 410 (i.e., client application 410 on client device 404a). For example, according to one embodiment, the file open command may be a file open callback that can be called to execute the opening of the file. In some such embodiments, client application 410 on client device 404a may execute the file open callback to open the file. In response to receiving the file open command, client application 410 on client device 404a may send (712) the file open command to server application 402a.

In response to receiving the file open command, server application 402a may execute (712) the file open command the file open command on the local copy of the decrypted file on server device 402 to open the file (e.g., open the local copy of the decrypted encrypted file 412 on server device 402). Server application 402a may then optionally send (716) a notification of the opening of the file for sharing to the client application being used by meeting attendee 406b.

Once the file is opened, meeting host 406a may use client application 410 on client device 404a and perform an action on the opened file to share its contents. For example, meeting host 406a may perform the action by providing an input, such as a keyboard input and/or a mouse input, to client application 410 on client device 404a. The performed action may cause a change in the state of the opened file which may be detected (718) by file event component 502 of client application 410 on client device 404a. In response to detecting the state change to the opened file, file event component 502 of client application 410 may generate a state change command corresponding to the detected state change to the opened file. File event component 512 may then send (720) the generated state change command to its client application 410 (i.e., client application 410 on client device 404a). In response to receiving the state change command, client application 410 on client device 404a may send (722) the state change command to server application 402a.

In response to receiving the state change command, server application 402a may execute (724) the state change command on the local copy of the decrypted file on server device 402. Execution of the state change command may generate a rendering of the state change to the file (e.g., rendering of the changed content) on server device 402. Server application 402a may then generate a video of the rendering of the state change and send (726) the video (e.g., a video stream) of the rendered state change to the client application being used by meeting attendee 406b. Upon receiving the video stream, the client application being used by meeting attendee 406b may render (728) the video stream on a screen (e.g., a screen of the client device on which the client application is executing) for viewing by meeting attendee 406b.

Interactions 718-728 may be repeated as necessary to process further actions performed by meeting host 406a (e.g., the meeting presenter) to share the contents of the opened file during the online meeting.

With continued reference to FIG. 7, meeting host 406a may use client application 410 on client device 404a to close the online meeting. For example, meeting host 406a may provide an input, such as a keyboard input and/or a mouse input, to client application 410 on client device 404a to close the online meeting. In response to the provided input, client application 410 on client device 404a may send (730) a request to end the online meeting to server application 402a. In response to the request, server application 402a may end the online meeting and send (732) a notification of the ending of the online meeting to the client application being used by meeting attendee 406b to attend the online meeting. In some embodiments, in response to receiving the request to end the online meeting, server application 402a may delete (e.g., wipe) (734) the local copy of the one or more encrypted files (e.g., encrypted file(s) 412) which were provided by meeting host 406a for sharing during the online meeting.

### FURTHER EXAMPLE EMBODIMENTS

The following examples pertain to further embodiments, from which numerous permutations and configurations will be apparent.

Example 1 includes a method including: storing, by the computing device, one or more encrypted files that are to be presented during an online meeting; receiving, by the computing device, an acceptance to an invitation of the online meeting by at least one invitee of the online meeting; and, responsive to the acceptance of the online meeting invitation by the at least one invitee, sending, by the computing device, the one or more encrypted files that are to be presented during the online meeting, wherein the invitee is prevented from accessing contents of the one or more encrypted files prior to a start of the online meeting.

Example 2 includes the subject matter of Example 1, further including receiving, by the computing device, a decryption key with a request to start the online meeting, the decryption key configured to decrypt the one or more encrypted files that are to be presented during the online meeting.

Example 3 includes the subject matter of Example 2, further including: receiving, by the computing device, a request from the at least one invitee to join the online meeting; and, responsive to receipt of the request to join the online meeting, sending, by the computing device, the decryption key to the at least one invitee.

Example 4 includes the subject matter of any of Examples 2 and 3, further including decrypting, by the computing device, the one or more encrypted files that are to be presented during the online meeting using the decryption key.

Example 5 includes the subject matter of any of Examples 2 through 4, further including: receiving, by the computing device, a command to perform an operation on the one or more encrypted files that are to be presented during the online meeting; and, responsive to receipt of the command, sending, by the computing device, the command to the at least one invitee.

Example 6 includes the subject matter of Example 5, wherein the command is to open one of the one or more encrypted files.

Example 7 includes the subject matter of Example 5, wherein the command is a state change to one of the one or more encrypted files.

Example 8 includes the subject matter of any of Examples 2 through 7, further including: decrypting, by the computing device, the one or more encrypted files that are to be presented during the online meeting using the decryption key; receiving, by the computing device, a command to perform an operation on the one or more encrypted files that are to be presented during the online meeting; rendering, by the computing device, the operation on the one or more encrypted files; and sending, by the computing device, a video of the rendered operation to the at least one invitee.

Example 9 includes the subject matter of any of Examples 2 through 8, further including, responsive to receipt of a request to end the online meeting, wiping, by the computing device, the one or more encrypted files.

Example 10 includes a system including a memory and one or more processors in communication with the memory and configured to: receive one or more encrypted files that are to be presented during an online meeting; receive an acceptance to an invitation of the online meeting by at least one invitee of the online meeting; and, responsive to the acceptance of the online meeting invitation by the at least one invitee, send the one or more encrypted files that are to be presented during the online meeting, wherein the invitee is prevented from accessing contents of the one or more encrypted files prior to a start of the online meeting.

Example 11 includes the subject matter of Example 10, wherein the one or more processors are further configured to receive a decryption key with a request to start the online meeting, the decryption key configured to decrypt the one or more encrypted files that are to be presented during the online meeting.

Example 12 includes the subject matter of Example 11, wherein the one or more processors are further configured to: receive a request from the at least one invitee to join the online meeting; and, responsive to receipt of the request to join the online meeting, send the decryption key to the at least one invitee.

Example 13 includes the subject matter of any of Examples 11 and 12, wherein the one or more processors are further configured to decrypt the one or more encrypted files that are to be presented during the online meeting using the decryption key.

Example 14 includes the subject matter of any of Examples 11 through 13, wherein the one or more processors are further configured to: receive a command to perform an operation on the one or more encrypted files that are to be presented during the online meeting; and, responsive to receipt of the command, send the command to the at least one invitee.

Example 15 includes the subject matter of Example 14, wherein the command is to open one of the one or more encrypted files.

Example 16 includes the subject matter of Example 14, wherein the command is a state change to one of the one or more encrypted files.

Example 17 includes the subject matter of any of Examples 11 through 16, wherein the one or more processors are further configured to: decrypt the one or more encrypted files that are to be presented during the online meeting using the decryption key; receive a command to perform an operation on the one or more encrypted files that are to be presented during the online meeting; render the operation on the one or more encrypted files; and send a video of the rendered operation to the at least one invitee.

Example 18 includes the subject matter of any of Examples 11 through 17, wherein the one or more processors are further configured to, responsive to receipt of a request to end the online meeting, wipe the one or more encrypted files.

Example 19 includes a method including: detecting, by an online meeting client application executing on a computing device, an operation on a file while content is being shared during an online meeting; and, responsive to the detection, sending, by the online meeting client application to an online meeting server application that is hosting the online meeting, a first command to perform the operation on the file, wherein the online meeting server application is to forward the first command to perform the operation on the file to at least one attendee in the online meeting.

Example 20 includes the subject matter of Example 19, wherein the first command is to open the file.

Example 21 includes the subject matter of Example 19, wherein the first command is a state change to the file.

Example 22 includes the subject matter of any of Examples 19 through 21, further including: receiving, by the online meeting client application from the online meeting server application that is hosting the online meeting, a second command to perform an operation on a file while content is being shared during the online meeting; and, responsive to receipt of the second command, rendering, by the online meeting client application, the operation associated with the second command on the file.

Example 23 includes a computing device including a memory and one or more processors in communication with the memory and configured to: detect an operation on a file while content is being shared during an online meeting; and, responsive to the detection, send a first command to perform the operation on the file to an online meeting server that is hosting the online meeting, wherein the online meeting server application is to forward the first command to perform the operation on the file to at least one attendee in the online meeting.

Example 24 includes the subject matter of Example 23, wherein the first command is to open the file.

Example 25 includes the subject matter of Example 23, wherein the first command is a state change to the file.

Example 26 includes the subject matter of any of Examples 23 through 25, wherein the one or more processors are further configured to: receive from the online meeting server application that is hosting the online meeting a second command to perform an operation on a file while content is being shared during the online meeting; and, responsive to receipt of the second command, render the operation associated with the second command on the file.

As will be further appreciated in light of this disclosure, with respect to the processes and methods disclosed herein, the functions performed in the processes and methods may be implemented in differing order. Additionally or alternatively, two or more operations may be performed at the same time or otherwise in an overlapping contemporaneous fashion. Furthermore, the outlined actions and operations are only provided as examples, and some of the actions and operations may be optional, combined into fewer actions and operations, or expanded into additional actions and operations without detracting from the essence of the disclosed embodiments.

In the description of the various embodiments, reference is made to the accompanying drawings identified above and which form a part hereof, and in which is shown by way of illustration various embodiments in which aspects of the concepts described herein may be practiced. It is to be understood that other embodiments may be utilized, and structural and functional modifications may be made without departing from the scope of the concepts described herein. It should thus be understood that various aspects of the concepts described herein may be implemented in embodiments other than those specifically described herein. It should also be appreciated that the concepts described herein are capable of being practiced or being carried out in ways which are different than those specifically described herein.

As used in the present disclosure, the terms “engine” or “module” or “component” may refer to specific hardware implementations configured to perform the actions of the engine or module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations, firmware implements, or any combination thereof are also possible and contemplated. In this description, a “computing entity” may be any computing system as previously described in the present disclosure, or any module or combination of modulates executing on a computing system.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two widgets,” without other modifiers, means at least two widgets, or two or more widgets). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “connected,” “coupled,” and similar terms, is meant to include both direct and indirect, connecting, and coupling.

All examples and conditional language recited in the present disclosure are intended for pedagogical examples to aid the reader in understanding the present disclosure, and are to be construed as being without limitation to such specifically recited examples and conditions. Although example embodiments of the present disclosure have been described in detail, various changes, substitutions, and alterations could be made hereto without departing from the spirit and scope of the present disclosure. Accordingly, it is intended that the scope of the present disclosure be limited not by this detailed description, but rather by the claims appended hereto.

What is claimed is:

1. A method comprising:
storing, by the computing device, one or more encrypted files that are to be presented during an online meeting;
receiving, by the computing device, an acceptance to an invitation of the online meeting by at least one invitee of the online meeting; and
responsive to the acceptance of the online meeting invitation by the at least one invitee, sending, by the computing device, the one or more encrypted files that are to be presented during the online meeting, wherein the invitee is prevented from accessing contents of the one or more encrypted files prior to a start of the online meeting.

2. The method of claim 1, further comprising:
receiving, by the computing device, a decryption key with a request to start the online meeting, the decryption key configured to decrypt the one or more encrypted files that are to be presented during the online meeting.

3. The method of claim 2, further comprising:
receiving, by the computing device, a request from the at least one invitee to join the online meeting; and
responsive to receipt of the request to join the online meeting, sending, by the computing device, the decryption key to the at least one invitee.

4. The method of claim 2, further comprising:
decrypting, by the computing device, the one or more encrypted files that are to be presented during the online meeting using the decryption key.

5. The method of claim 2, further comprising:
receiving, by the computing device, a command to perform an operation on the one or more encrypted files that are to be presented during the online meeting; and
responsive to receipt of the command, sending, by the computing device, the command to the at least one invitee.

6. The method of claim 5, wherein the command is to open one of the one or more encrypted files.

7. The method of claim 5, wherein the command is a state change to one of the one or more encrypted files.

8. The method of claim 2, further comprising:
decrypting, by the computing device, the one or more encrypted files that are to be presented during the online meeting using the decryption key;
receiving, by the computing device, a command to perform an operation on the one or more encrypted files that are to be presented during the online meeting;
rendering, by the computing device, the operation on the one or more encrypted files; and
sending, by the computing device, a video of the rendered operation to the at least one invitee.

9. The method of claim 2, further comprising:
responsive to receipt of a request to end the online meeting, wiping, by the computing device, the one or more encrypted files.

10. A system comprising:
a memory; and
one or more processors in communication with the memory and configured to:
receive one or more encrypted files that are to be presented during an online meeting;
receive an acceptance to an invitation of the online meeting by at least one invitee of the online meeting; and
responsive to the acceptance of the online meeting invitation by the at least one invitee, send the one or more encrypted files that are to be presented during the online meeting, wherein the invitee is prevented from accessing contents of the one or more encrypted files prior to a start of the online meeting.

11. The system of claim 10, wherein the one or more processors are further configured to receive a decryption key with a request to start the online meeting, the decryption key configured to decrypt the one or more encrypted files that are to be presented during the online meeting.

12. The system of claim 11, wherein the one or more processors are further configured to:
receive a request from the at least one invitee to join the online meeting; and
responsive to receipt of the request to join the online meeting, send the decryption key to the at least one invitee.

13. The system of claim 11, wherein the one or more processors are further configured to decrypt the one or more encrypted files that are to be presented during the online meeting using the decryption key.

14. The system of claim 11, wherein the one or more processors are further configured to:
receive a command to perform an operation on the one or more encrypted files that are to be presented during the online meeting; and
responsive to receipt of the command, send the command to the at least one invitee.

15. The system of claim 14, wherein the command is one of to open one of the one or more encrypted files or a state change to one of the one or more encrypted files.

16. The system of claim 11, wherein the one or more processors are further configured to:
decrypt the one or more encrypted files that are to be presented during the online meeting using the decryption key;
receive a command to perform an operation on the one or more encrypted files that are to be presented during the online meeting;
render the operation on the one or more encrypted files; and
send a video of the rendered operation to the at least one invitee.

17. The system of claim 11, wherein the one or more processors are further configured to, responsive to receipt of a request to end the online meeting, wipe the one or more encrypted files.

18. A method comprising:
detecting, by an online meeting client application executing on a computing device, an operation on a file while content is being shared during an online meeting; and
responsive to the detection, sending, by the online meeting client application to an online meeting server application that is hosting the online meeting, a first command to perform the operation on the file, wherein the online meeting server application is to forward the first command to perform the operation on the file to at least one attendee in the online meeting.

19. The method of claim 18, wherein the first command is one of to open the file or a state change to the file.

20. The method of claim 18, further comprising:
receiving, by the online meeting client application from the online meeting server application that is hosting the online meeting, a second command to perform an operation on a file while content is being shared during the online meeting; and
responsive to receipt of the second command, rendering, by the online meeting client application, the operation associated with the second command on the file.
